(19) United States
(12) Patent Application Publication
(10) Pub. No.: US 2006/0036356 A1
(43) Pub. Date: Feb. 16, 2006

(54) System and method of vehicle policy control

(76) Inventors: Vladimir Rasin, Northville, MI (US); Craig Simonds, Dearborn, MI (US)

Correspondence Address: PRICE, HENEVELD, COOPER, DEWITT & LITTON, LLP, 695 KENMOOR S.E., P. O. BOX 2567, GRAND RAPIDS, MI, 49501-2567, US

(21) Appl. No.: 10/916,789

(22) Filed: Aug. 12, 2004

(51) Int. Cl. G06F 7/00

(52) U.S. Cl. 701/1; 701/2

(57) ABSTRACT

A system and method are provided for controlling functional application of electronic devices operating in a vehicle. The system includes first and second electronic devices located in a vehicle and operating at least one application. The system also includes an application programming interface for allowing the first electronic device to interface with the second electronic device. The system further includes memory storing in a database policy data including policy rules and logic for controlling functionality of a device made available in the vehicle. The system has a policy controller for applying the rules and logic in the policy data and controlling the one or more functions based on the application of the rules and logic.

### BACKGROUND OF THF INVENTION

The present invention generally relates to integrated control of electronics onboard a vehicle and, more particularly, to a system and method of controlling functions made available with electronic systems and devices employed onboard a vehicle.

Automotive vehicles are being equipped with increasing numbers of electronic controllers and related devices. Conventional vehicles generally employ multiple sensors and control modules that may communicate a very limited and defined set of data via a proprietary communication protocol on a dedicated vehicle data communication bus. For example, the vehicle original equipment manufacturer (OEM) data communication bus is generally coupled to an engine control module, a chassis control module, a power train control module, a body module, onboard diagnostics, a speedometer, a fuel level sensor (gauge), and various other electronic devices.

Additionally, automotive vehicles are also being equipped with various infotainment devices such as an audio radio tuner, a compact disc (CD) or digital versatile disc (DVD) player, a television, and a navigation system. These and other onboard integrated electronic devices are generally interfaced with one or more human machine interfaces (HMIs), such as a visual display with user input keypads or a voice-based human machine interface employing a microphone and one or more audio speakers. These devices may be individually coupled to a multi-media bus, which is typically separated from the vehicle OEM data communication bus.

In addition to the onboard integrated devices, various wireless consumer electronic devices may also be utilized in the vehicle. For example, cellular phones, personal digital assistants (PDAs), and digital music players, such as an MP3 player, brought into a vehicle by a passenger may have some limited ability to communicate with each other and one or more devices integrated in the vehicle via wire or wireless (e.g., Bluetooth) data communication link(s).

These devices and communication systems collectively provide multiple sources of data and information and offer various functions that can be useful in performing a wide variety of tasks and/or objectives. For example, it may be desirable for a vehicle navigation system to provide customized navigation services based on vehicle status information, user preferences, and/or weather and traffic information. Additionally, it may be desirable to integrate a human machine interface in a vehicle with a cell phone to provide integrated access and control of the cell phone or make cell phone communication available to communicate data for use in other devices.

As future vehicles become even more intelligent and electronic devices are further integrated in the vehicle, the total functionality provided by such devices will grow and become more difficult to control. The uncontrolled availability of certain functions made available by these devices can be problematic. For example, some functional aspects made available by electronic devices can be distractive to the driver of the vehicle. Additionally, uncontrolled access to certain functions made available with some electronic devices can become an annoyance and can be relatively complex to operate.

Accordingly, it is desirable to provide for a system and method of controlling the functionality made available with multiple electronic devices operating in a vehicle. In particular, it is desirable to provide for a system and method of managing the complexity of the in-vehicle infrastructure in a manner that is beneficial to the passengers in the vehicle. For example, it is desirable to provide for enhanced integration and operation of a PDA when employed in the vehicle.

### SUMMARY OF THE INVENTION

According to one aspect of the present invention, a system is provided for controlling application of one or more electronic devices operating in a vehicle. The system includes a first electronic device located on a vehicle and operating at least one application, and a second electronic device located on the vehicle. The system also includes an interface for allowing the first electronic device to interface with the second electronic device. The system further includes memory storing policy data including policy rules for one or more services and logic for controlling functions available with at least one of the first and second electronic devices. The system has a policy controller for applying the rules in the policy data to determine whether one or more of the functions may be performed and controlling the one or more functions based on the application of the rules and logic.

According to a further aspect of the present invention, a method of controlling application of one or more electronic devices operating in a vehicle is provided. The method includes the steps of providing a first electronic device and a second electronic device in a vehicle and interfacing the first electronic device with the second electronic device in the vehicle. The method also includes the steps of storing policy data comprising rules for defining policy and logic to be applied to the rules. The method further includes the steps of initiating an application of at least one of the first and second electronic devices and applying the rules in the policy data to determine whether at least one of the functions can be performed based on the policy data. The method further controls the one or more functions based on the application of the rules and logic.

The system and method of the present invention advantageously controls the functionality made available by one or more electronic devices operating in a vehicle. This is achieved by applying a set of policy data comprising rules and logic that control whether a given function may be allowed to operate within the vehicle. The rules and logic may be provided by a vehicle manufacturer or other authorized supplier.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings.

FIG. 1 is a perspective view of the cockpit of a vehicle equipped with an electronics (e.g., infotainment) system having integrated user interfacing electronic devices.

FIG. 2 is a block diagram illustrating a vehicle consumer services interface (VCSI) host platform interfacing with a plurality of electronic devices in the vehicle.

FIG. 3 is a block diagram illustrating the functional layout of the VCSI host platform shown in FIG. 2.

FIG. 4 is a block diagram illustrating one example of the use of a policy application programming interface (API) according to the present invention.

FIG. 5 is a block diagram illustrating applications operating with the policy API.

FIG. 6 is a block diagram illustrating policy entries containing rules, logic and actions for implementing the policy API in the VCSI host platform.

FIG. 7 is a block diagram illustrating interaction of the VCSI host platform with a vehicle manufacturer server to acquire updated policy data.

FIG. 8 is a block diagram illustrating registration and activation of the VCSI policy, according to one embodiment.

FIGS. 9A and 9B are a state diagram further illustrating the VCSI policy registration and activation of FIG. 8.

FIG. 10 is a block diagram illustrating execution of the VCSI policy, according to one embodiment.

FIGS. 11A and 11B are a state diagram further illustrating the VCSI policy execution of FIG. 10.

FIG. 12 is a block diagram illustrating the updating of policy information on the VCSI host platform, according to one embodiment.

FIGS. 13A and 13B are a state diagram further illustrating the updating of policy information of FIG. 12.

FIGS. 14A and 14B illustrate a flow diagram for applying the policy API to an electronic device brought into the vehicle, according to one example.

### DETAILED DESCRIPTION OF THE PREFERRED EMBODIMENT

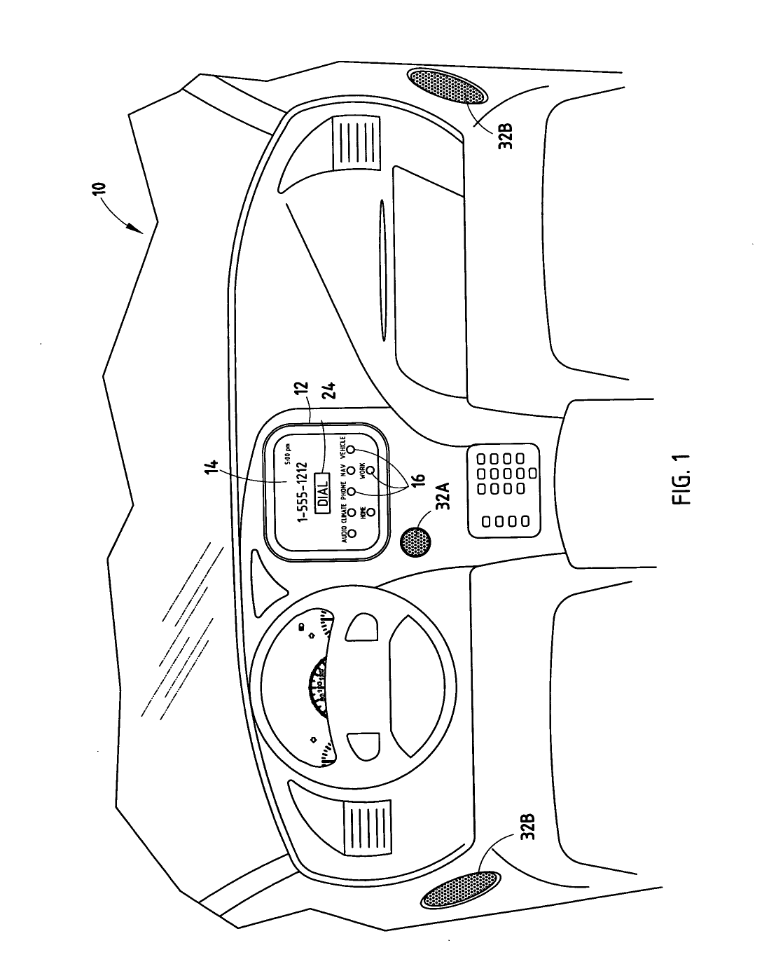

Referring to FIG. 1, the cockpit of a vehicle 10 is generally illustrated having an integrated electronics system, also referred herein as an infotainment system according to one embodiment, generally located in the vehicle dashboard and made accessible to passengers in the vehicle 10. The infotainment system serves to provide any of a number of services as should be evident to those skilled in the art. These services may include handling a wide variety of information and providing informational services including entertainment services and telematics services, and thus may serve as an entertainment/telematics system.

The electronics system shown includes a main visual human machine interface (HMI) 12 in the form of a touch-screen display 14 that allows passengers in the vehicle 10 to interface with the electronics system to communicate with one or more electronic devices that are made available onboard the vehicle 10. The term electronic devices includes any of a wide variety of devices, systems, machines, and services employing analog and/or digital electronics to process and/or communicate data. The touch-screen display 14 may include a conventional image display for displaying visual images and for providing a plurality of touch-screen inputs, such as the “dial” input button 24 and the following menu inputs 16: audio input, climate input, phone input, navigation input, vehicle input, home input, and work input, as well as a wide variety of other menu selections (not shown). It should be appreciated that various user inputs and outputs may be made available with the HMI 12 for inputting and outputting information (data) that may be used with any of a plurality of electronic devices to allow a user to interface with the electronic devices.

Also shown located within the cockpit of the vehicle 10 is a microphone 32A and audio speakers 32B, which together form a voice-based HMI 32. The microphone 32A is an audio input device that allows for voice speech recognition as a means to provide audio command inputs to the electronics system and the electronic devices. The speakers 32B are audio output devices that may include audio entertainment speakers commonly employed for audio devices in the vehicle 10 and/or may include one or more audio speakers dedicated to providing voice command audio outputs to passenger(s) in the vehicle 10. It should be appreciated that the electronics system, including the electronic devices and HMIs 12 and 32, may be located at various locations within the vehicle 10. In addition, the vehicle 10 may be equipped with other HMIs, such as a visual HMI employed in front of the rear passenger seat to allow occupants seated in the rear seat of the vehicle to interface with an entertainment system or other electronic device(s).

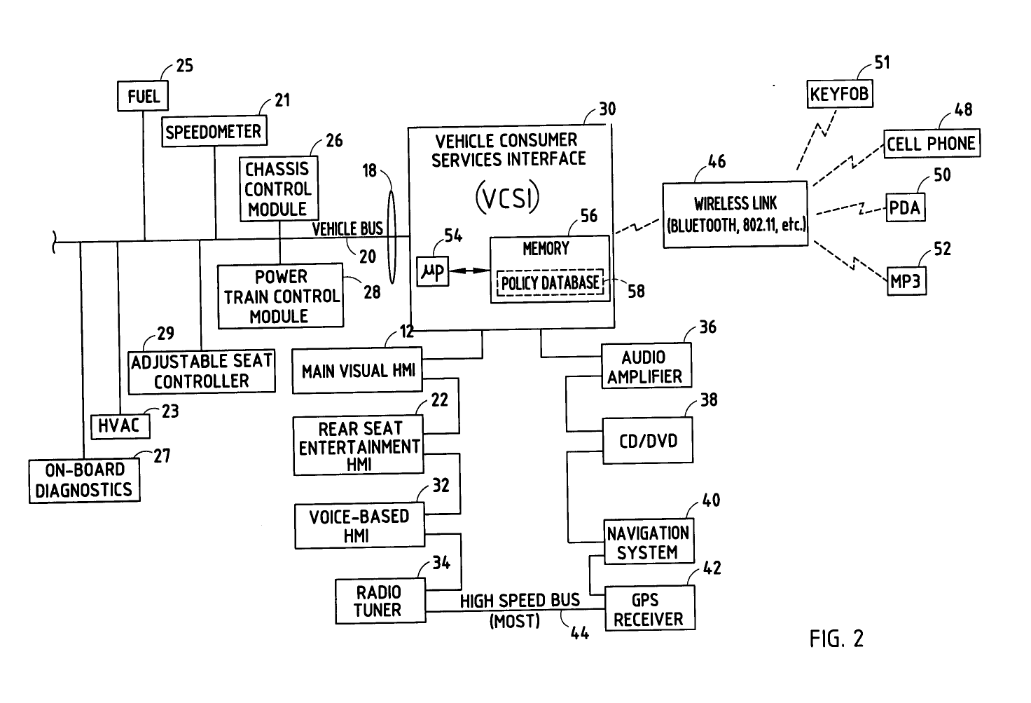

The electronics system also includes a plurality of information and entertainment devices that may be used onboard the vehicle 10. Examples of various electronic devices included with the infotainment system providing entertainment and telematics services onboard the vehicle 10 are illustrated in FIG. 2. The electronics (e.g., infotainment) system includes various electronic devices coupled to a vehicle consumer services interface (VCSI) host platform 30. The VCSI platform 30 interfaces with the various electronic host devices within the vehicle 10.

VCSI host platform 30 is shown coupled to the vehicle data bus 20, a high speed media oriented system transport (MOST) bus 44, and one or more wireless links 46. The vehicle bus 20 may include a conventional original equipment manufacturer (OEM) bus, such as a CAN or J1850 bus, utilizing a proprietary or non-proprietary protocol dedicated to communicating information (data) among vehicle dedicated control devices including chassis control module 26 and power train control module 28. The vehicle data bus 20 is also coupled to various other vehicle devices and sensors including a vehicle speedometer 21, a fuel level sensor 25, onboard diagnostics 27, heating, ventilation and air conditioning (HVAC) controls 23, and adjustable seat controls 29, as well as various other vehicle devices and services (not shown) as should be evident to those skilled in the art. The vehicle bus 20 is coupled to the VCSI host platform 30 via a firewall 18 which serves to shield mission critical functions of the vehicle 10 from potentially harmful communications.

The VCSI host platform 30 allows various electronic devices in the vehicle 10 to interface with each other, to interface with off-board electronic devices, and to interface with the HMIs. The VCSI host platform 30 serves as the interface between consumers, networks (both internal and external networks), electronic devices (factory installed or purchased by consumers “off-the-shelf”), and the vehicle 10. The VCSI host platform 30 serves as a bridge between different protocols to provide a standardized interface that makes the task of creating in-vehicle applications easy, and further serves to synchronize both automotive and non-automotive technology electronic devices to that of the vehicle 10. The applications provide services that are implemented through intelligent electronic devices that reside on one or more of the networks. The VCSI host platform 30 may implement network protocols already designed into the vehicle 10 and may enable communication between electronic devices (including services) residing on different networks. The VCSI host platform 30 may also implement application programming interfaces (APIs), thus enabling compatibility and communication between electronic devices (including services) provided by a variety of potentially different suppliers. It should be appreciated that the VCSI host platform 30 further includes a communication manager that handles the sending and receiving of messages that are communicated through the VCSI host platform 30.

The VCSI host platform 30 includes a compute platform, shown as a microprocessor 54 and memory 56 for storing and executing a plurality of software routines. The memory 56 in the VCSI host platform 30 includes both volatile and non-volatile memory, such as random access memory (RAM), read-only memory (ROM), electronically erasable programmable read-only memory (EEPROM), and flash memory. The compute platform includes microprocessor 54 for executing various software routines. The VCSI host platform 30 stores and executes various applications to perform various program services. The VCSI host platform 30 also manages the storage of information regarding each of the services. It should be appreciated that the software routines implemented in the VCSI host platform 30 and elsewhere in the electronics system may employ object-oriented programming. An example of an object-oriented programming language may include JAVA, which is a commercially available software package. It should also be appreciated that other programming languages may be employed.

The VCSI host platform 30 further contains a policy database 58 provided in memory 56, preferably within non-volatile memory. The policy database 58 contains data parameters stored in memory that make up a set of rules and logic decisions that control the functionality of certain aspects of the vehicle and/or customer interface. The policy data stored in database 58 is initially supplied from an off-board server, such as from an original equipment manufacturer or other authorized supplier. The policy data stored in database 58 can be reprogrammed by communicating with the off-board server subsequent to the initial data programming. Thus, the policy data is updateable. The policy rules defined by the policy data are implemented by a policy application programming interface (API) which interacts with in-vehicle applications to determine whether certain functions of an application are able to operate in the vehicle based on the policy rules defined by the policy data.

The high speed MOST bus 44 is implemented, in one embodiment, as a wire bus connected in communication with a plurality of electronic devices including the main visual HMI 12. Other HMI devices, including the rear seat entertainment HMI 22 and the voice-based HMI 32, are also connected to the high speed MOST bus 44. Electronic devices shown connected to the MOST bus 44 include a radio tuner 34, an audio amplifier 36, a compact disc/digital versatile disc (CD/DVD) player 38, a navigation system 40, and a global position system (GPS) receiver 42. The high speed MOST bus 44 allows data communication between each of the electronic devices coupled to the bus 44 and the VCSI host platform 30. It should be appreciated that the HMIs 12, 22, and 32 may be otherwise coupled in communication with the VCSI host platform 30 to provide data communication between a user and the VCSI host platform 30 or between the user and any of the electronic devices. While the VCSI host platform 30 is referred to herein as the host platform, it should be understood that any of the host electronic devices (e.g., a radio tuner 34, CD/DVD player 38, a navigation system 40) may be configured to operate as the host platform to execute applications, communicate data, and to store and execute the policy API and policy data according to the present invention. It should also be appreciated that other electronic devices having interface capability may serve to function as HMIs.

The VCSI host platform 30 is further able to communicate with various wireless electronic devices including consumer electronic devices such as a cell phone 48, a personal digital assistant (PDA) 50, and a media player (e.g., MP3 player) 52, via a wireless link 46. The PDA 50 may include any of a number of digital electronic devices generally having processing capability and memory for storing and communicating data information. For example, the PDA 50 may include a personal computing device (e.g., laptop computer) having a processor and Internet access. According to another example, PDA 50 may include a key fob 51 having memory for storing information that may be communicated to the vehicle 10 and for receiving and storing information from the vehicle 10. It should be appreciated that various other PDAs 50 may be utilized onboard the vehicle 10 as well as off-board the vehicle 10. The consumer electronic devices including cell phone 48, PDA 50, MP3 player 52, and key fob 51 are portable and able to be transported in and out of the vehicle 10 and communicate data with the vehicle 10 via the wireless link 46.

The wireless link 46 may include any of a number of wireless communication links including, but not limited to, Bluetooth and 802.11B. Bluetooth provides for wireless communication generally within a short range (e.g., ten meters), while 802.11B provides enhanced range (e.g., three hundred meters) wireless data communication. It should be appreciated that other wire and wireless links, including long range (beyond three hundred meters) wireless links may be employed to provide data communication between electronic devices in and/or near the vehicle 10 and one or more wireless communication devices. It should also be appreciated that a user may interface with any of the wireless devices (e.g., cell phone) via any of the HMIs 12, 22, and 32 communicating via the VCSI host platform 30. Additionally, any of the wireless devices may also operate as the host platform to execute applications, communicate data, and store and execute the policy rules set forth in the policy data according to the present invention.

The electronics system, referred to in one embodiment as the vehicle infotainment system, includes the integration of a number of electronic devices (including systems, machines, and services) that offer entertainment telematics functions to allow for enhanced operation of a plurality of onboard electronic devices and off-board electronic devices for use in the vehicle 10. To manage the complexity of the in-vehicle infrastructure resulting from integrated use of a plurality of electronic devices, a policy application programming interface (API) is employed in conjunction with stored policy data containing established rules, logic, and actions to control one or more functions made available with the various electronic devices.

In the embodiment shown and described herein, the policy API and policy data are implemented in the VCSI host platform 30 which serves as the policy controller. One example of a VCSI host platform 30 and its use for communicating data within a vehicle is disclosed in U.S. application Ser. Nos. 10/696,597; 10/696,078; 10/696,473; 10/696,692; and 10/695,717, all filed on Oct. 29, 2003, and commonly assigned to the assignee of the present application. The entire disclosures of each of the aforementioned patent applications are hereby incorporated herein by reference. While the policy API implemented herein is described in connection with the VCSI host platform 30, it should be appreciated that the policy API and policy data may be implemented (stored and executed) in any of a variety of electronic devices, preferably having processing capability and memory for storing the policy data and processing the policy rules, logic, and actions.

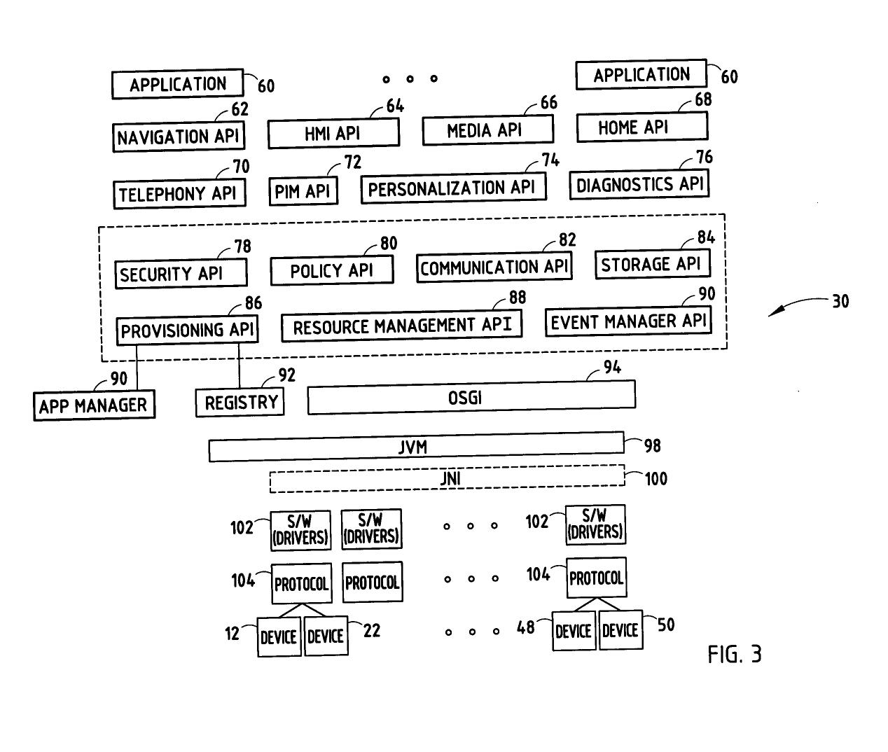

Referring to FIG. 3, functions performed by the VCSI host platform 30 including implementation of the policy control, according to one embodiment of the present invention, is illustrated therein. The VCSI host platform 30 processes and executes a number of in-vehicle applications which operate with various application programming interfaces (API). The applications 60 include functions for implementing navigation, media applications, telephone applications, personalization related applications, vehicle diagnostics applications, and various other applications. The application programming interfaces include a navigation API 62, an HMI API 64, a media API 66, a home API 68, a telephone API 70, a personal information management (PIM) API 72, a personalization API 74, and diagnostics API 76. Additionally, the VCSI host platform 30 includes other application programming interfaces including a security API 78, a policy API 80, a communication API 82, a storage API 84, a provisioning API 86, a resource management API 88, and an event manager API 90. The various application programming interfaces allow for interaction with various electronic devices and resources to perform interface functions. The application programming interfaces allow for integration and, hence, interaction among electronic devices employed in connection with the vehicle.

The policy API 80 is a software interface logically separated from other parts of in-vehicle software. The policy API 80 is abstracted from the existing in-vehicle infrastructure, but may leverage other software in its operation. The policy API 80 is implemented in software as a policy object stored in memory in the VCSI host platform 30, according to one embodiment, and includes policy related decisions, such as technical, business, and marketing related policy decisions that are represented in the policy object. The policy object defines a set of rules and decisions that affect the functionality of the vehicle and electronic devices employed onboard the vehicle, including interfacing and communicating with various electronic devices. The rules and decision logic included in the policy object may include governmental regulations, corporate policy, safe driving practice requirements, security requirements, and may or may not be tied to a specific vehicle model or platform.

The security API 78 may be implemented as part of the policy API 80 or may be separate therefrom. The security API 78 may include a set of rules and decision logic for controlling available functionality of the vehicle and/or electronic devices employed in the vehicle for purposes of ensuring security of the vehicle, electronic devices, and/or the interface and communication of data information. It should also be appreciated that a safety API could be employed as part of the policy API 80 or separate therefrom to provide rules and decision logic that affect the safety aspects related to functionality of the vehicle and/or electronic devices employed onboard the vehicle. While security, safety, and other specific functional aspects of a policy API may be implemented separately or integrated together in the policy API 80, it should be appreciated that the policy API 80 encompasses a general and/or specific set of rules and decision logic that affect functionality of the vehicle and/or use of electronic devices onboard the vehicle.

The VCSI host platform 30 is further shown configured with an application manager 90, a registry 92, and open services gateway initiative (OSGI) 94. Also configured in the VCSI host platform 30 are a Java virtual machine (JVM) 98 and a Java native interface (JNI) 100. The VCSI host platform 30 communicates with any of a number of electronic devices, such as devices 12, 22, 48, and 50, by way of communication protocol 104 and software (S/W) drivers 102. Accordingly, the VCSI host platform 30 is able to control applications and functionality made available with such applications that affect electronic devices 12, 22, 48, and 50 by employing the policy API 80. Policy API 80 allows or disallows certain functionality as a function of the rules and decision logic set forth in the policy API 80 according to the present invention.

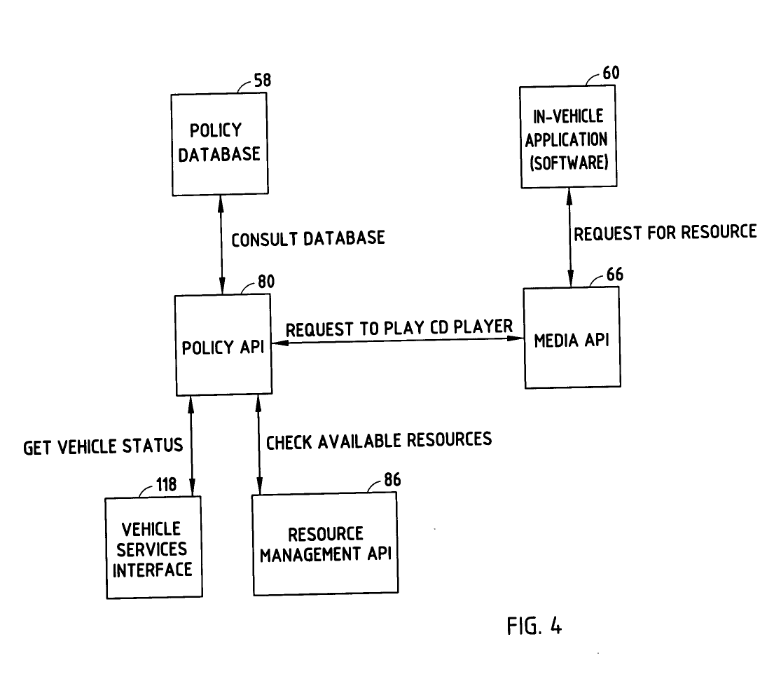

One example of implementation of the policy API 80 is shown in FIG. 4 controlling the functionality made available with an electronic device in the form of the CD player by applying the policy rules. The media API 66 initiates a request for a resource from the in-vehicle application 60, and initiates a request to the policy API 80 to play (operate) the CD player. The policy API obtains the vehicle status from a vehicle services interface 118. The policy API 80 also checks with the resource management API 86 on the availability of resources. The policy API 80 then consults the policy database 58 to obtain rules that affect the functionality made available with the use of the CD player and makes a decision on what functionality is available. Based on the decision reached by the policy API 80, a decision on the request to play the CD player is made and the available functionality of the CD player is controlled based on the policy rules and logic. The decisions are made by the policy controller (e.g., VCSI host platform) processing the policy rules and decision logic. Accordingly, the policy API 80 decides when and to what extent one or more functional features of the CD player can be employed in the vehicle based on policy rules and logic stored in the policy database 58 and executed via the policy API 80 via the microprocessor in the policy controller. These policy rules and logic may be updated as need be, and may reflect governmental regulations, corporate policy, recommended safe driving practices, security requirements, and may be based on other conditions.

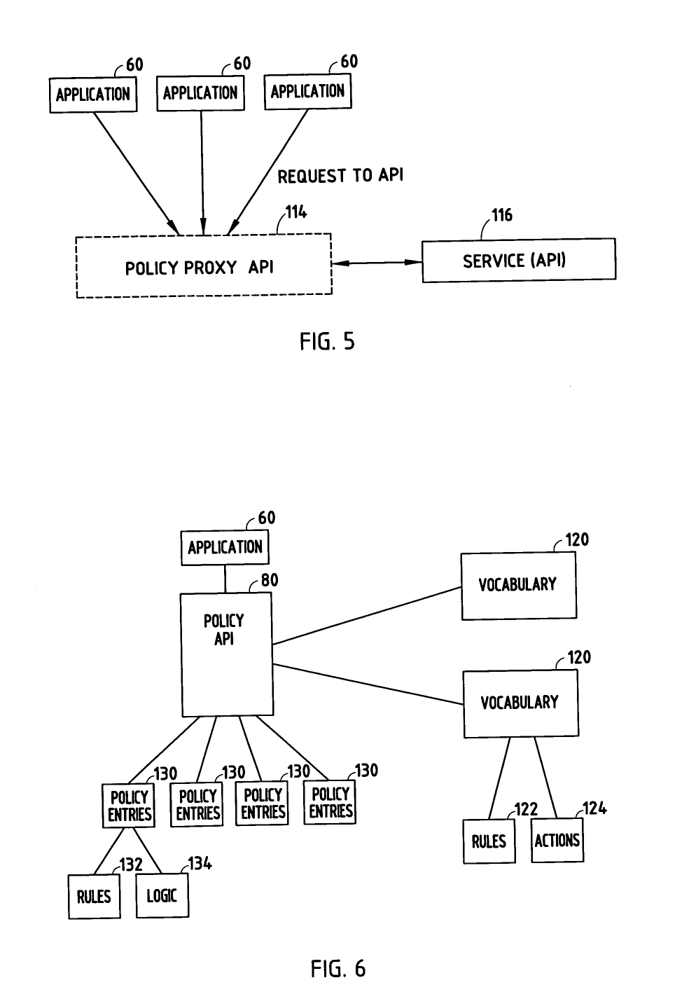

Applications 60 are shown in FIG. 5 requesting implementation and execution of the policy rules each time an action is requested by an application 60. The requests for action from applications 60 are shown directed to a policy proxy API 114. The policy proxy API 114 is a proxy for the policy API that filters actions that may or may not involve the policy object. If participation of the policy object for a particular action is required, then the request from an application 60 will be filtered through the proxy API 114 which will allow or disallow the request to pass to the policy object.

Each application 60 can interact with in-vehicle resources through the software interface defined by the vehicle manufacturer or other authorized vehicle services supplier. This insures that the policy object will be consulted each time an action is requested. Each time an in-vehicle application requires some action that affects in-vehicle resources (e.g., send message from one device to another), the policy proxy API 114 will become active. The policy proxy API 114 will then filter the actions that involve the policy API and send the request onto the policy API 80. Thus, the policy proxy API 114 acts as an interface between application 60 and a service 116.

Referring to FIG. 6, implementation of the policy API 80 via the VSCI host platform is further illustrated therein. The policy API 80 includes a plurality of policy entries 130 stored in memory. Each policy entry 130 includes rules 132 and decision logic 134. The rules 132 and decision logic 134 may include dynamic data entries including rules and decisions programmed by a vehicle manufacturer that affect the functionality of the vehicle and/or electronic devices employed onboard or in connection with the vehicle. The policy entries are dynamic in that they may be updated by programming new policy entries in memory that define the policy API 80. The policy entries may include data related to business, technical, environmental, safety, security, and regulatory conditions that affect operation of the vehicle and/or the electronic devices employed onboard or otherwise in connection with the vehicle. While the policy entries are dynamic sets of data, the in-vehicle software may remain static. The policy API 80 applies the dynamic data to in-vehicle software and transforms the static set of in-vehicle software into dynamic behavior of the vehicle systems controlled by the software.

The policy entries 130 may be stored in memory in the VCSI host platform, according to the embodiment disclosed herein. The policy entries 130 may be stored in extensible markup language (XML) format which allows for easy updating of the dynamic data without adversely affecting in-vehicle software, including the VCSI host platform 30. One example of XML format for transferring and storing data is disclosed in U.S. patent application Ser. No. 10/637,418, filed on Aug. 8, 2003, the entire disclosure of which is hereby incorporated herein by reference.

The policy entries 130 stored in and executed by the VCSI host platform 30 are also shown employing vocabulary objects 120 to dynamically verify the rules. The vocabulary objects 120 include a set of rules 122 and actions 124 associated with the rules 122. The actions 124 may include any of the methods of the VCSI host platform APIs. For example, an audio bus captured rule may be associated with the method get bus status of the media API, and current audio source rule may be associated with the method get audio source of the same API. The implementation of vocabulary objects 120 enables easy updating of the rules 122 and actions 124 of the vocabulary.

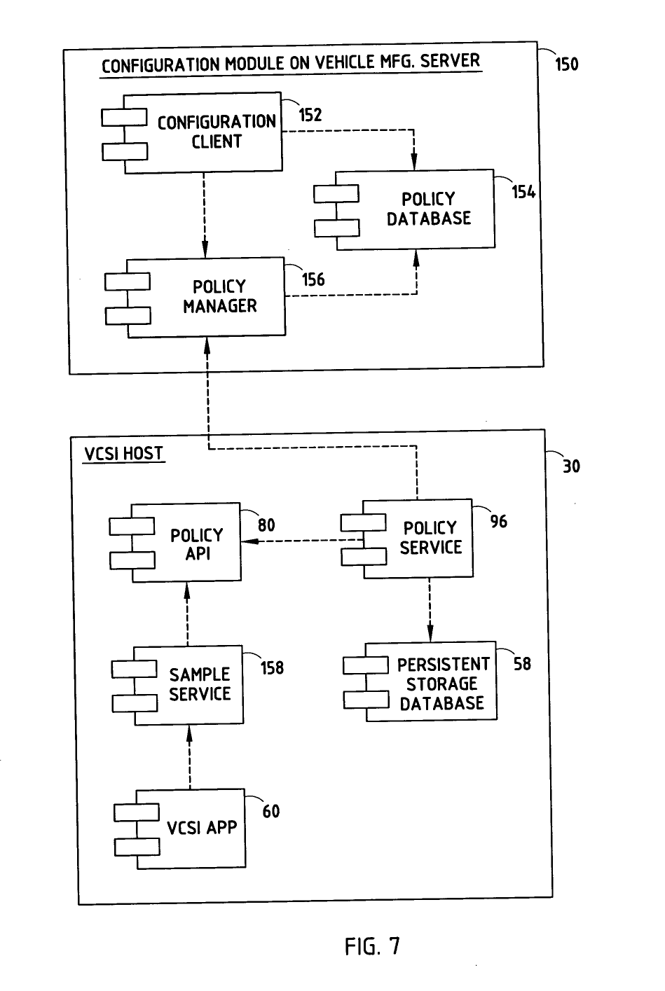

An authorized policy service provider, such as a vehicle manufacturer, may load policy data into the policy database 58 when the vehicle electronics are initially configured or at any subsequent time for use by the policy object and policy API. One example of the loading of policy data from a vehicle manufacturer to the VCSI host platform 30 is illustrated in FIG. 7. The VCSI host platform 30 communicates data via a secured wire or wireless connection with a configuration module on a vehicle manufacturer server 150. The off-board configuration module 150 includes a configuration client 152, a policy database 154, and a policy manager 156. The policy database 154 includes the policy data made available to one or more vehicles for downloading into a specific vehicle. The policy manager 156 manages the request for policy data and manages the controlled availability of the policy data for downloading from the configuration module 150 to the VCSI host platform 30.

The VCSI host platform 30 is shown including a policy service 96 in communication with a persistent storage database 58 in memory 56 and also in communication with the policy API 80. Additionally, the VCSI application 60 and sample service 158 are shown communicating with the policy API 80. The vehicle manufacturer programming of policy data from policy database 154 can be provisioned into the vehicle from the off-board server 150 either at the vehicle assembly line or after the vehicle is delivered. In doing so, the policy object in the policy API 80 captures relevant requirements from the off-board server 150 via a predefined protocol for storage in the internal database in the VCSI host platform 30.

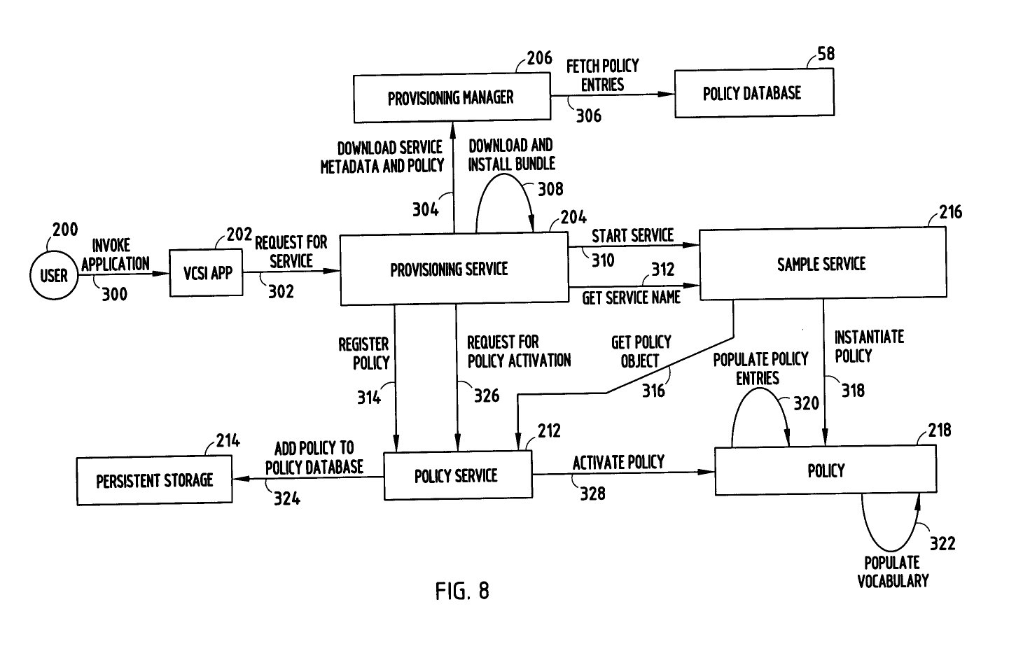

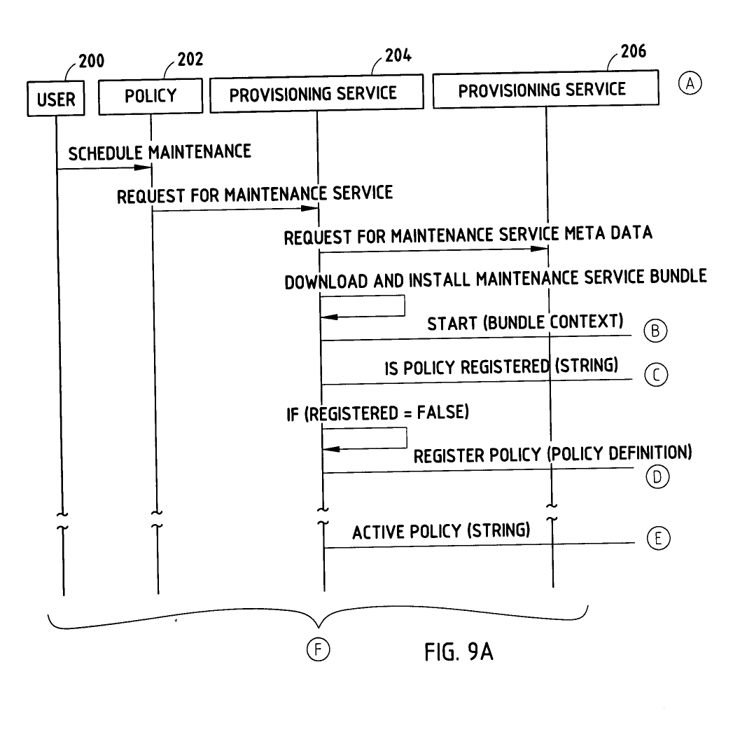

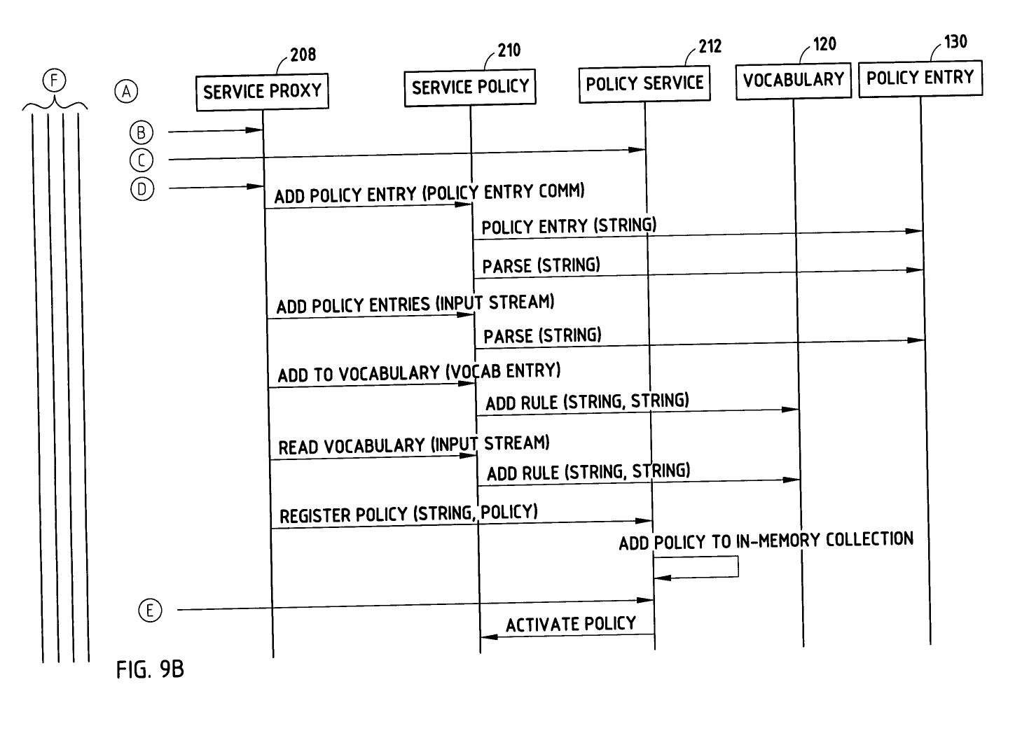

Referring to FIGS. 8 and 9A-9B, registration and activation of the policy API implemented in the VCSI host platform is shown according to one embodiment. In order to enforce policy rules on a particular service, the policy API for the corresponding object needs to be registered and activated. The registration and activation of the policy API begins with a user 200 invoking a VCSI application 202 in step 300. Next, in step 302, the VCSI application 202 issues a request to the provisioning service 204 for a service that is needed for use. The provisioning service 20 is responsible for registering the policy with the policy service 212. The provisioning service 204 downloads the metadata for the service and the policy definition from the provisioning manager 206 in step 304. The provisioning manager 206 then fetches the policy data entries from the policy database 58 in step 306.

Once the policy data is fetched from the policy database 58, provisioning service 204 installs the service bundle in step 308, and then starts the sample service 216 in step 310. When the sample service 216 is started for the first time, the provisioning service 204 gets the service name in step 312, and then requests the policy service 212 to register the policy for that service in step 314. The policy service 212 gets the policy object in step 316 for the sample service 216. Proceeding to step 318, the sample service 216 instantiates the policy. The policy entries are populated in policy block 218 in step 220, and the vocabulary is populated in policy block 218 in step 322.

Following the population of the policy entries and vocabulary in steps 320 and 322, the policy service 212 adds the policy object to the persistent storage 214 in step 324. The provisioning service 204 then requests for activation the policy to the policy service 212 in step 326. The policy service 212, in turn, invokes an activation method on the policy object 218 in step 328. Accordingly, the policy object for the corresponding service is registered and activated, and the policy object is now ready for execution.

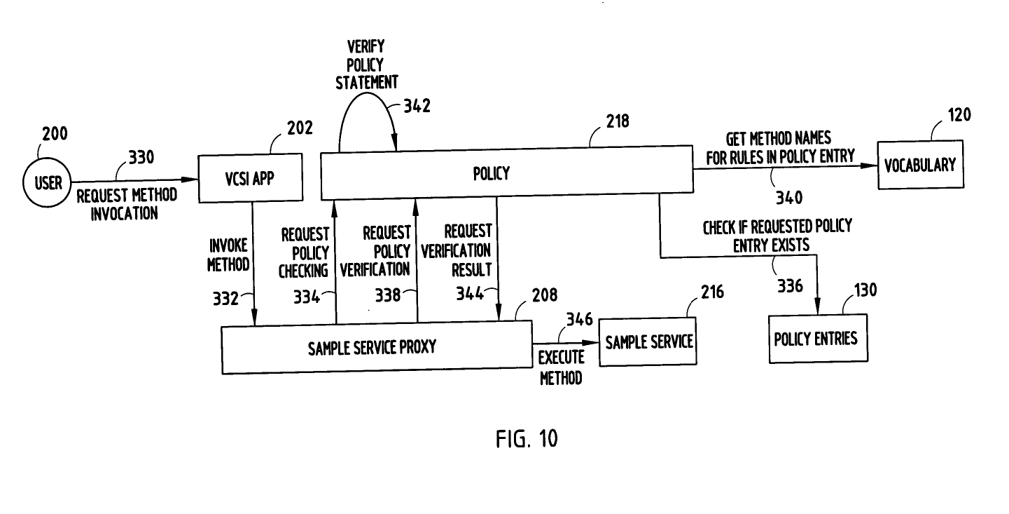

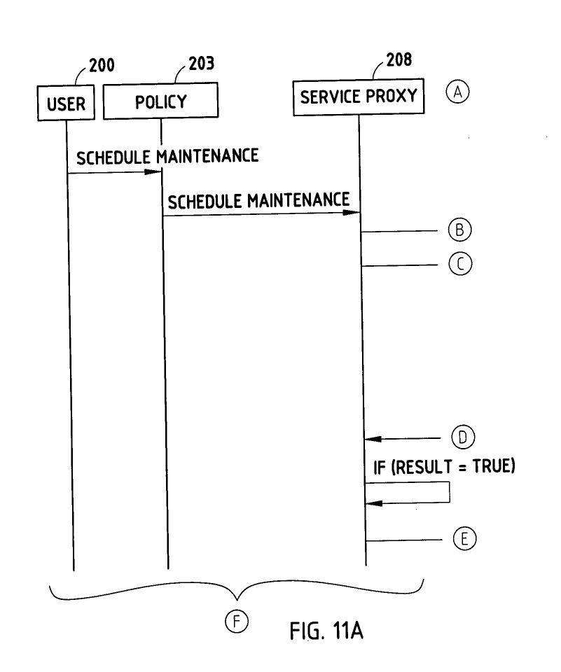

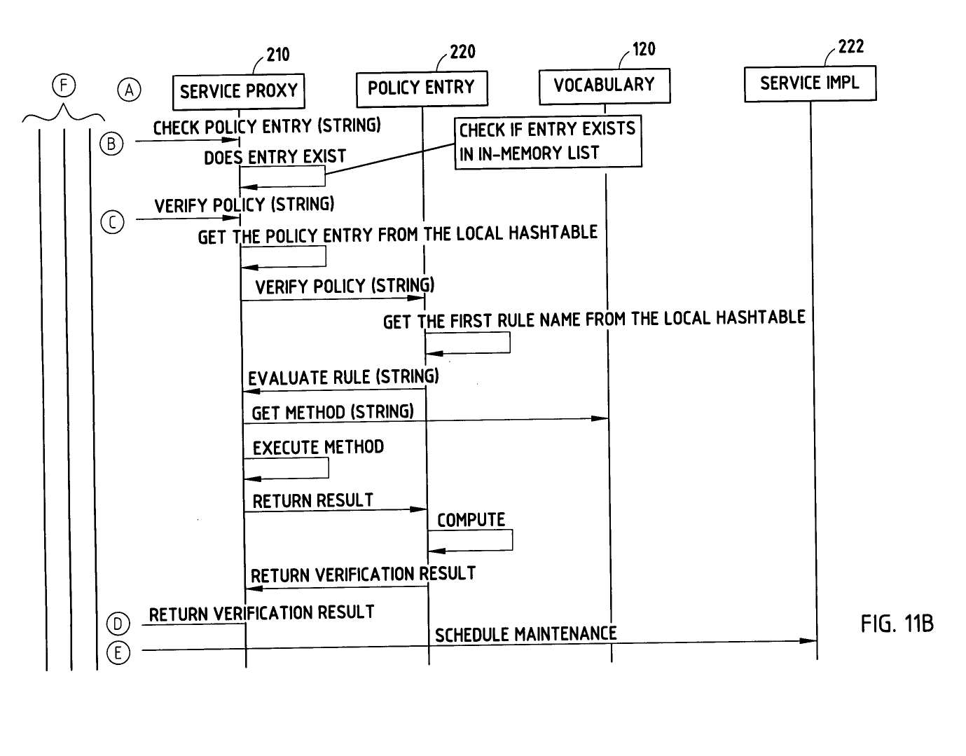

Execution of the policy API with the VCSI host platform is illustrated in FIGS. 10 and 11A-11B, according to one embodiment. Execution of the policy API involves checking if a policy entry exists for a particular service API to be invoked and, if it exists, then the policy statement is verified to check if the operation is allowed. Execution of the policy API begins in step 330 with a user 200 requesting a method invocation on the sample service through the VCSI application 202. The VCSI application 202 invokes, in step 332, a method on the sample service proxy 208. It is the responsibility of the service proxy 208 to check if the criteria for method execution is met and then call the method.

In step 334, the sample service proxy 208 initiates a request to check if policy verification is required for a particular method. This request is made to the policy object 218. The policy object 218 then checks, in step 336, the collection of policy entries to find if a policy entry exists for the method to be invoked and returns the result to the sample service proxy 208. The sample service proxy 208 then requests the policy verification in step 338.

In step 340, the policy object 218 retrieves the required policy entry, fetches the function names corresponding to the rules in the policy entry for the pool of methods maintained in the policy. Next, in step 342, the policy object executes the functions to evaluate the rules. The result of the rule verification is returned to the sample service proxy 208 in step 344. If verification is successful, the sample service proxy 208 calls the method on the sample service 216 in step 346. Accordingly, the policy object is executed to determine whether to allow or disallow operation of a function.

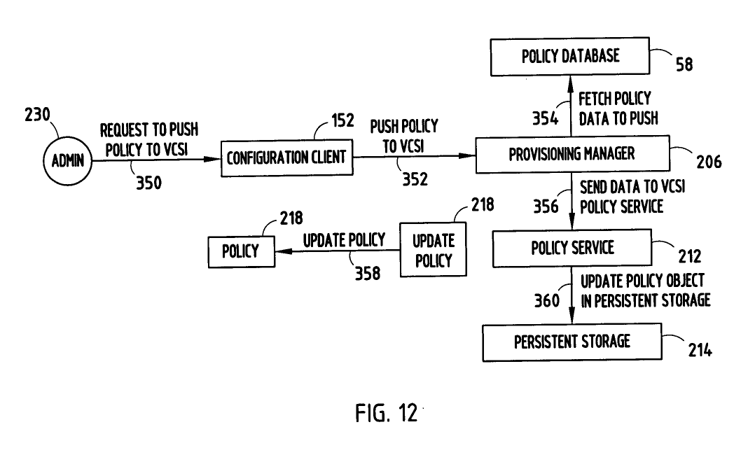

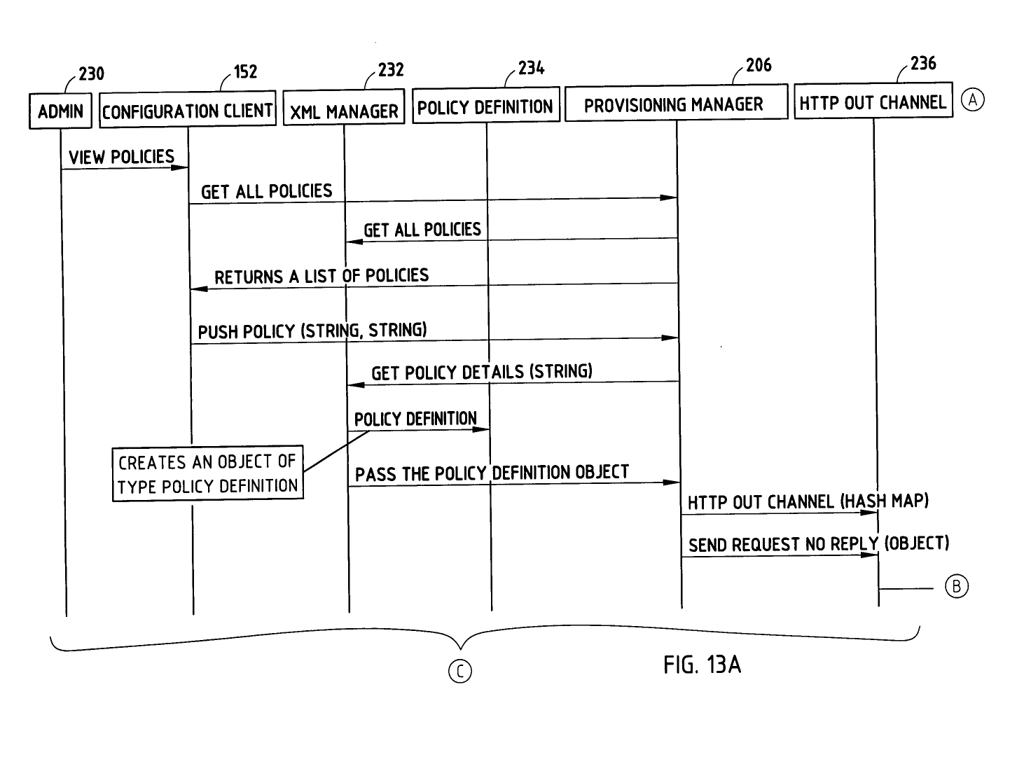

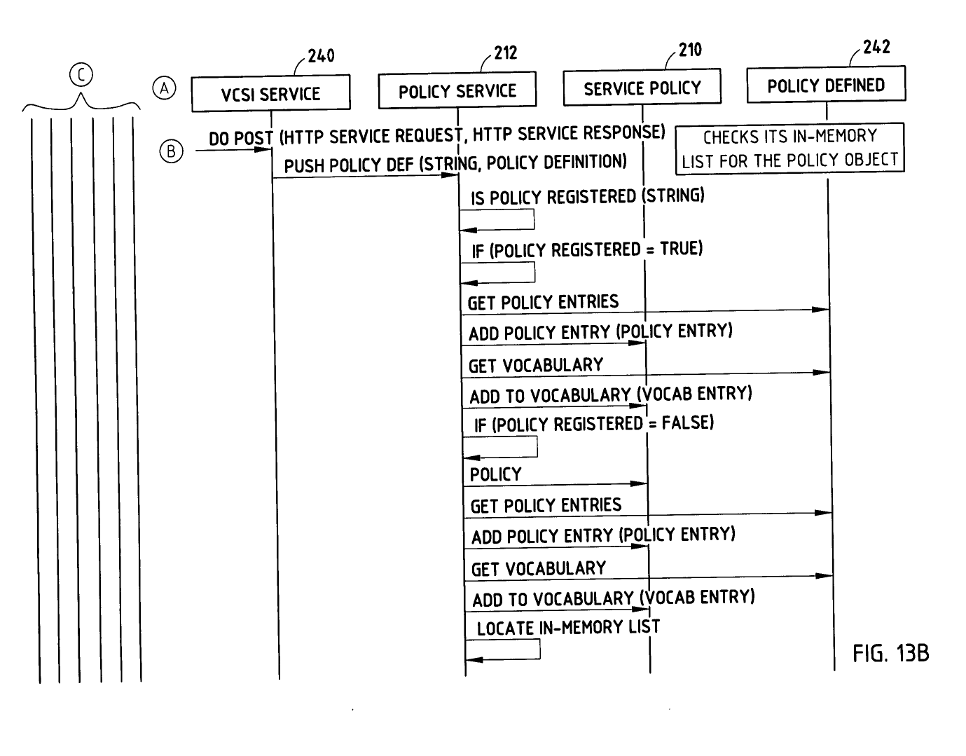

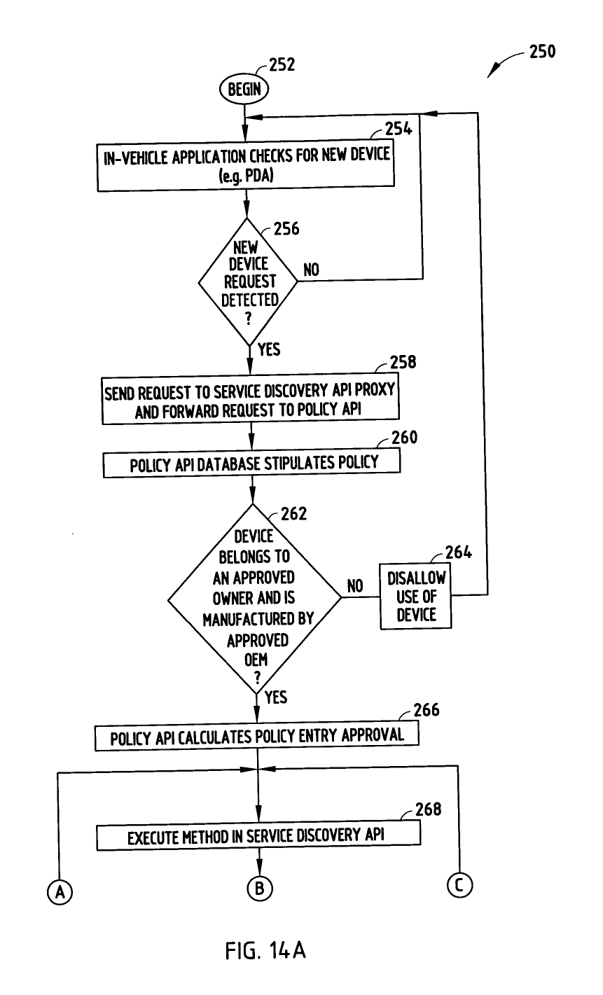

Referring to FIGS. 12 and 13A-13B, the updating of policy information in the VCSI host platform implementation is illustrated, according to one embodiment. An authorized vehicle services provider (e.g., vehicle manufacturer) can enforce a policy on the in-vehicle services once the policy definition is updated on the configuration model. The vehicle services provider can push the updated policy details through the configuration client interface. The updating of policy data may occur with wire or wireless data communication using known secure data transfer techniques.

To update policy information, an administrator 230 of the authorized vehicle services provider issues a request to update the policy on the VCSI host platform through the configuration client 152 in step 350. Next, in step 352, the configuration client 152 forwards the request to the provisioning manager 206 in step 352. The provisioning manager 206 fetches the details from the policy database 58 in step 354. The provisioning manager 206 then communicates with the policy service 212 to pass the updated policy details in step 356. The policy service 212 updates the policy 218 with the latest details in step 358, and then updates the persistent storage 214 with the modified policy in step 360. Accordingly, an authorized vehicle services provider is able to update and provide dynamic policy data to the vehicle.

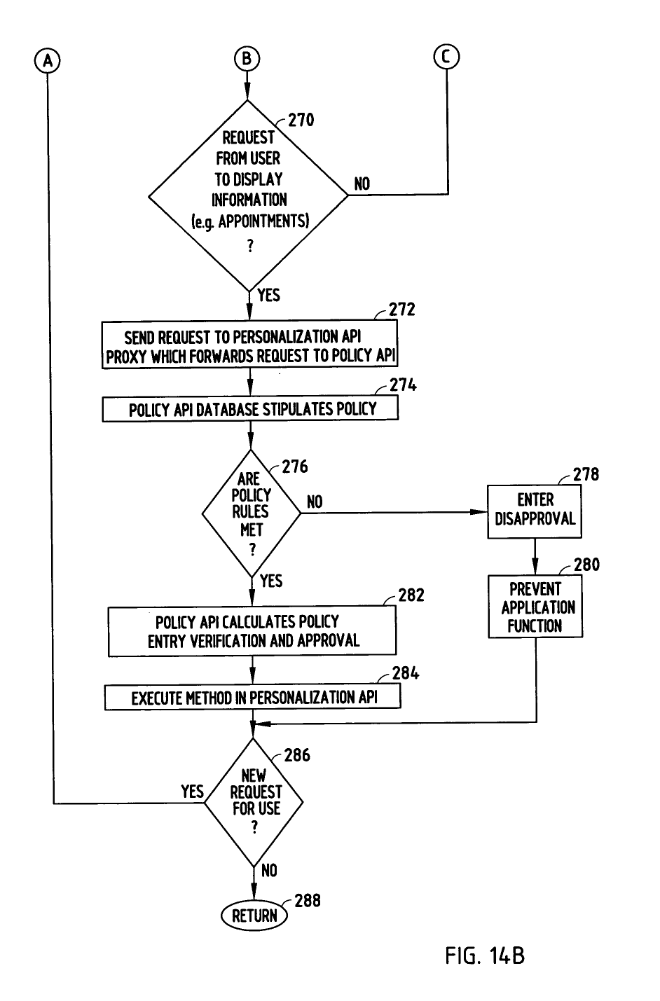

Referring to FIGS. 14A-14B, a method 250 of applying and executing the policy API in a vehicle is illustrated in one example for a safety and/or security policy API in which a vehicle passenger brings a PDA (electronic device) into the vehicle and would like to use the data in the PDA for integrated use onboard the vehicle. Method 250 begins at step 252 and proceeds to step 254 in which the in-vehicle application checks for a request for a new electronic device, such as a PDA. In decision step 256, method 50 determines if a new device request has been detected and, if not, returns to the beginning. If a new device request has been detected, method 250 proceeds to step 258 in which the application sends a request to the service discovery API proxy to initiate connection to the PDA. The service discover API proxy forwards the request to the policy API.

Next, in step 260, the policy API database stipulates through respective policy entries that in case of discovery of a new electronic device, the vehicle will be allowed to work with this electronic device if the device belongs to one of the owners listed in an approved list and the device is manufactured by an authorized manufacturer that is on the list of authorized devices. This is achieved in decision step 262 by determining if the electronic device belongs to an approved owner and is manufactured by an approved OEM and, if not, disallowing use of certain functions related use of the device in step 264 in the vehicle. If the electronic device is an approved device, the policy API calculates policy entry approval in step 266 verifying both conditions are met and proceed with method 250 in step 268.

Proceeding to step 268, the method in the service discovery API is executed as usual. In decision step 270, method 250 checks for whether there has been a request for certain functions from the user, such as to display on the in-vehicle display appointments or other information contained in the PDA and, if not, returns to step 268. If there has been a request from the user to display such information, method 250 sends the request to the personalization API proxy which, in turn, forwards the request to the policy API in step 272.

In step 274, the policy API database stipulates through respective policy entries that such request could be approved. This is achieved by decision step 276 checking for whether the policy rules are met and, if not, entering disapproval in step 278 and preventing the application of one or more certain functions in step 280. For example, if the display is not viewable by the driver (e.g., a rear seat entertainment display), or if the vehicle speed is less than a predetermined speed (e.g., 10 miles per hour), approval to perform the requested function is granted. If the policy rules are met, the policy API calculates the policy entry verification and approval in step 282 and executes the method in personalization API 284. Thus, when the policy rules are met, the application is able to perform the requested one or more functions. Thereafter, application 250 proceeds to check for a new request for use in decision step 286 and returns if no such request is detected.

It should be appreciated that policy API may be applied to provide enhanced arbitration between in-vehicle resources and applications. For example, the policy API may arbitrate to determine control on an audio bus in an environment having multiple audio sources including a navigation speaker, a CD player, a phone, etc. Other examples of the policy API include enabling and disabling certain function features based on rules and regulations and vehicle locations, such as when rules and regulations are different in different geographic regions (e.g., states and countries). Further applications of the policy API include defining rules depending on vehicle status and business environment. It should be appreciated that various other general and specific policy rules may be defined and executed according to the teachings of the present invention.

Accordingly, the policy API advantageously enhances the management of complex integration of vehicle electronics in a manner that is beneficial to passengers in the vehicle. The policy API allows for enhanced control of functions made available onboard the vehicle and the electronic devices mounted in the vehicle and brought onboard the vehicle, particularly when multiple electronic devices are integrated within the vehicle. The policy data is easily updateable to accommodate changes in governmental regulations, business environments, vehicle status, safety and security concerns, and to handle arbitration of multiple electronic devices.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

The invention claimed is:

1. A system for controlling application of one or more electronic devices operating in a vehicle, said system comprising:
a first electronic device located in a vehicle and operating at least one application;
a second electronic device useable in the vehicle;
an interface for allowing the first electronic device to interface with the second electronic device;
memory storing policy data comprising policy rules and logic for controlling functions available with at least one of the first and second electronic devices; and
a policy controller for applying the rules and logic in the policy data to determine whether one or more of the functions may be performed and controlling the one or more functions based on the application of the rules and logic.

2. The system as defined in claim 1, wherein the policy data is stored in a database in memory and is updateable.

3. The system as defined in claim 1, wherein the interface comprises an application programming interface.

4. The system as defined in claim 1, wherein the policy data comprises policy entries and vocabulary for services.

5. The system as defined in claim 4, wherein said vocabulary comprises mapping rule names to function names.

6. The system as defined in claim 1, wherein said policy entries comprise a collection of policy rules.

7. The system as defined in claim 1, wherein the first electronic device comprises a human machine interface.

8. The system as defined in claim 1, wherein said interface comprises a wireless interface for wireless communication between the first electronic device and said second electronic device.

9. The system as defined in claim 1, wherein said second electronic device is a consumer electronic device brought into the vehicle by a passenger.

10. The system as defined in claim 1, wherein the first electronic device comprises an onboard vehicle device.

11. A method of controlling application of one or more electronic devices operating in a vehicle, said method comprising the steps of:
providing a first electronic device in a vehicle;
providing a second electronic device in the vehicle;
interfacing the first electronic device with the second electronic device;
storing policy data comprising rules for defining policy and logic for controlling one or more functions made available with at least one of the first and second electronic devices;
initiating an application of the first and second electronic devices;
applying the rules and logic in the policy data to determine whether the one or more functions of the application can be performed based on the policy data; and
controlling an action to perform the one or more functions based on the application of the rules and logic.

12. The method as defined in claim 11 further comprising the step of denying a function of the application as a function of the policy data.

13. The method as defined in claim 11 further comprising the step of updating the policy data in a database in memory.

14. The method as defined in claim 11, wherein the step of interfacing comprises interfacing the first electronic device with the second electronic device via an application programming interface.

15. The method as defined in claim 11 further comprising the step of storing policy entries and vocabulary for services as the policy data.

16. The method as defined in claim 15 further comprising the step of mapping rule names to function names in the vocabulary.

17. The method as defined in claim 11 further comprising the step of storing a collection of policy rules as policy entries.

18. The method as defined in claim 11, wherein said step of interfacing comprises wireless interfacing between the first electronic device and said second electronic device.

19. The method as defined in claim 11, wherein said second electronic device is a consumer electronics device brought into the vehicle by a passenger.

20. The method as defined in claim 11 further comprising the step of interfacing the first electronic device with a passenger in the vehicle.
